(19) United States
(12) Patent Application Publication
(10) Pub. No.: US 2014/0298868 A1
(43) Pub. Date: Oct. 9, 2014

(54) COMPUTER SECURITY SYSTEM

(71) Applicant: ANDREW K. RICHARDS, Manchester, NH (US)

(72) Inventor: ANDREW K. RICHARDS, Manchester, NH (US)

(21) Appl. No.: 13/857,988

(22) Filed: Apr. 5, 2013

(51) Int. Cl. E05B 73/00

(52) U.S. Cl. CPC E05B 73/0082
USPC 70/15

(57) ABSTRACT

Disclosed is a security system for computers and computer peripherals having a plurality of cables, wherein each cable has a first end and a second end and is attached to a cable collar at the first end, and a computer lock, wherein the computer lock comprises a lock body for receiving said cable collar, wherein said cable collar is securely retained on the lock body with an end piece removable only when the computer lock is not attached to a computer or a computer peripheral, thereby creating a security system for computers and computer peripherals with readily interchangeable cables.

### CROSS-REFERENCE TO RELATED APPLICATIONS

This patent application claims priority to U.S. provisional patent application No. 61/620,484, filed 5 Apr. 2012, the disclosures of which are incorporated by reference herein in their entirety.

### FIELD OF THE INVENTION

The present invention relates to a physical computer security system and more particularly to computer locks with readily interchangeable cables for use in securing portable computers, desktop computers, and peripherals to structures.

### BACKGROUND OF THE INVENTION

With the introduction of the Internet, and the increasing dependence on mobile technology, a need for systems to secure portable computers, desktop computers, and other peripheral equipment has developed. Many desktop and portable computers, as well as peripheral devices have universal security slots, including for example, Kensington Security Slots. Peripheral devices include, but are not limited to, printers, projectors, monitors, televisions, tablets, and iPads (some of which have hard cases that feature a universal security slot, and others have a universal security slot built into the device itself).

People are often traveling with their portable devices to and from work and school, and even on vacation. Never the less, one cannot always have his portable device in hand. There are times when one needs to step away from the device leaving it vulnerable to theft. In fact, one of the most common ways that personal information is compromised is through the “loss” of a computer that contains the user's private information. This private information may belong to the owner of the device, or perhaps the private user information has been entrusted to the owner by his employer, or his customers. In fact, according to a 2008 study by Dell, approximately 640,000 laptops are lost and/or stolen from airports each year.

Currently, there are computer locks on the market that include padlocks, combination locks, and even scissor locks. Some of these locks use keys, and others do not. Some use cables, and some do not. If the locks do have cables, the cables are often attached to the lock bodies in ways that make their interchangeability difficult or impossible.

Disclosed is a physical computer security system with a key-operated or combination computer lock and several quick-release, easily interchangeable cables. The readily interchangeable cables allow for ease of use and flexibility without a loss of security. This ease of use can translate into higher compliance with security policies. Another aspect is a key-operated or combination computer lock with quick-release, easily interchangeable cables comprising a threaded end piece made of flexible, yet durable material that allows for a tighter, more secure fit between the lock face and the portable computer.

### SUMMARY OF THE INVENTION

Disclosed is a security system for computers and computer peripherals having a plurality of cables, wherein each cable has a first end and a second end and is attached to a cable collar at the first end, and a computer lock, wherein the computer lock comprises a lock body for receiving said cable collar, wherein said cable collar is securely retained on the lock body with an end piece removable only when the computer lock is not attached to a computer or a computer peripheral thereby creating a security system for computers and computer peripherals with readily interchangeable cables.

Disclosed is a security system for computers and computer peripherals having a plurality of cables, wherein each cable has a first end and a second end and the cable is attached to a cable collar at the first end, and a computer lock, wherein the computer lock features a lock body for receiving said cable collar, wherein the cable collar is securely retained on the lock body with quick-release/quick-connect mechanism only when the computer lock is not attached to a computer or a computer peripheral, thereby creating a security system for computers and computer peripherals with readily interchangeable cables.

These aspects of the disclosure are not meant to be exclusive and other features, aspects, and advantages of the disclosure will be readily apparent to those of ordinary skill in the art when read in conjunction with the following description, appended claims, and accompanying drawings.

### BRIEF DESCRIPTION OF THE SEVERAL VIEWS OF THE DRAWINGS

The foregoing and other objects, features, and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a side view of one embodiment of the physical computer security system for interchangeable cables.

FIG. 2 shows a side view of one embodiment of the physical computer security system for interchangeable cables.

FIG. 3 shows a side view of one embodiment of the physical computer security system for interchangeable cables.

FIG. 4 shows a side view of one embodiment of the physical computer security system for interchangeable cables.

FIG. 5 shows one embodiment of an irreversibly connected cable collar for interchangeable cables.

FIG. 6 shows one embodiment of an anchor mount for interchangeable cables.

FIG. 7 shows one embodiment of an anchor mount for interchangeable cables.

FIG. 8A, FIG. 8B, FIG. 8C, and FIG. 8D show several perspective views of one embodiment of a reversibly connected cable collar for interchangeable cables.

FIG. 9 shows a side view of one embodiment of the physical computer security system for interchangeable cables.

FIG. 10 shows a side view of one embodiment of the physical computer security system for interchangeable cables.

FIG. 11A and FIG. 11B show several perspective views of one embodiment of a reversibly connected cable collar for interchangeable cables.

FIG. 12A, FIG. 12B, FIG. 12C and FIG. 12D show disassembled and assembled views of one embodiment of reversibly connected anchor mount for cables.

FIG. 13 shows a side perspective of one embodiment of the physical computer security system for interchangeable cables.

FIG. 14A, FIG. 14B, and FIG. 14C show several perspective views of one embodiment of a reversibly attached combination dial for the present invention.

FIG. 15A and FIG. 15B show side prospective views of two embodiments of the physical computer security system for interchangeable cables.

FIG. 16 shows a side prospective of one embodiment of a key for the present invention.

FIG. 17A and FIG. 17B show a side and back prospective view, respectively, of one embodiment of a key operated physical computer security system.

### DETAILED DESCRIPTION OF THE INVENTION

There is a need for an improved key-operated or combination computer lock and a computer security system that comprises easily interchangeable cables. The interchangeability of cables allows users readily to disconnect the lock from the cable and transport the locked portable computer to another location where a second cable may be located. This is of particular interest to people who have multiple offices. It is also of particular interest to institutions such as businesses, colleges, libraries, airports, or internet cafes that could provide tethered interchangeable cables to their patrons as a value-added service.

Interchangeable cables vary in length and thickness depending on the desired application. The interchangeable cables can be customizable in a variety of colors, and with company names, institution names, or even sports teams printed on the cables. To be most effective as a component of a security system, the cables should be difficult to cut. In one embodiment, the cables are coated, multi-stranded carbon-strengthened steel cable. Cables can be made of various materials and be of various lengths.

In one embodiment the interchangeable cable is about 1 foot long, about 2 feet long, about 3 feet long, about 4 feet long, about 5 feet long, about 6 feet long, about 7 feet long, about 8 feet long, about 9 feet long, or about 10 feet long.

In one embodiment the interchangeable cable thickness is about 2 mm, about 3 mm, about 4 mm, about 5 mm, about 6 mm, about 7 mm, about 8 mm, about 9 mm, or about 10 mm.

In one embodiment the interchangeable cable is a coiled cable so as to reduce the amount of space it occupies. A lightweight coiled cable could be used while traveling so that the user would not have to choose between losing precious space in their luggage or sacrificing security. The lightweight coiled cable could fit easily in the pocket of a carry-on and provide the flexibility to lock a computer to any fixture. A traveler could also bring several cables, including the thicker cables, which may be coiled or straight, for added security, giving them the ability to choose the most appropriate cable considering the tradeoff between weight and the level of protection afforded.

There is a need for cables of different lengths and thicknesses so that a user's computer or device may be tethered to various structures or fixtures located at various distances from the computer or device without having cables which are too long or too short. The cables could be either irreversibly, or reversibly, tethered to an anchor mount for convenience. Additionally, the anchor mount could contain a mechanism to retract the cable to improve the aesthetics of an area when the computer or device is not present, and to provide access to a variety of effective cable lengths to attach to various portable devices or computers while minimizing the area occupied by the cable on a work surface.

In addition to cables that are permanently attached to anchor mounts, cables could have a loop at the end opposite the cable collar for ease of use when traveling or when visiting a location where there is no anchor mount already installed.

There is also a need for an improved key-operated or combination computer lock and a computer security system that comprises a series of cables which are pre-attached to cable collars which are in turn readily attached to a computer lock in a quick-connect/quick release fashion. The quick-connect/quick-release mechanism could include a snap on, or click on, or the like. The cable could be interchangeable by sliding the cable collar onto the lock body and having it clink in place, or attaching an end piece, as discussed in more detail below. Further, the cable collar could be threaded and itself screw onto the lock body to provide interchangeable cables.

The quick-connect/quick-release feature for the interchangeable cables for the computer lock and computer security system could also be configured to act as a quick-connect lock. In that case, a key or combination, if present, would only be necessary for unlocking the lock from the computer. Connecting the computer to the cable and locking it on the computer could be a one-step process, which would greatly increase security policy compliance.

In addition to interchangeable cables which are pre-attached to various cable collars, it is also contemplated that the cables could be reversibly, pivotally connected to the cable collars through a ball and socket-type mechanism. As one of ordinary skill in the art can appreciate, the mechanism for reversibly “attaching” the cable to the collar could be comprised of countless complimentary shapes, and the criteria would be that the interchangeable cable would need to able to quickly connect to the cable collar and then mount to the lock body to secure the locked computer to a fixture. One other option would be inserting a roll or “spring pin” behind the ball inside the collar to prevent its removal. The spring pin could be inserted through two holes so that it is visible on either side of collar or through one side in a manner that would further frustrate removal because it would prevent someone from “punching it out” with an awl or similar device. In additional to being pivotally connected, the cables could be reversibly fixed in position in the collar (e.g. non-pivotally connected).

There is also a need for an improved key-operated or combination computer lock and a computer security system that comprises readily interchangeable cables in which the system comprises a threaded end piece comprised of a material that is not only easily removable to affect the interchangeability of the cable collar, but that is constructed of a material that is durable and flexible. The threaded end piece must be constructed of a material that withstands multiple instances of screwing on and off the computer lock body, but must also have enough flexibility to allow the lock body to securely seat against the portable device or computer providing a more secure connection. This is particularly important for some computer lock interfaces, such as with Apple® products which have an oval security slot on the portable device. In one embodiment the threaded end piece comprises a polymer, rubber, foam rubber, silicone rubber, and the like.

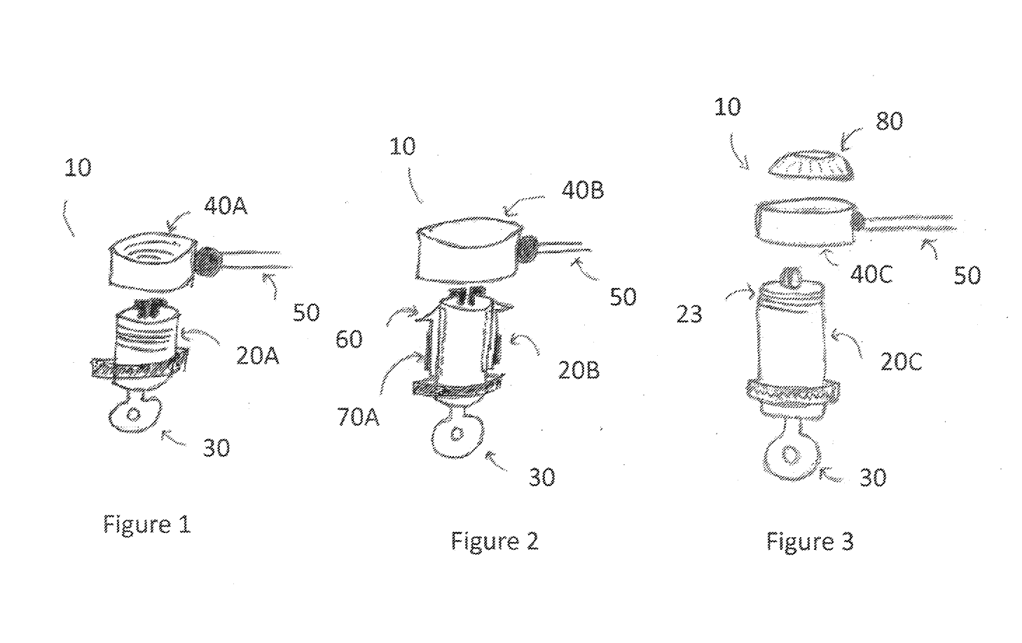

In FIG. 1, a side view of one embodiment of the physical computer security system for interchangeable cables 10 is shown (the opposite end of the cable is not shown). More specifically, a representative lock body 20A is shown with a key 30 and a cable collar 40A attached to a cable 50. Referring to FIG. 1, the cable collar 40A is threaded and it threads onto the lock body 20A to provide interchangeable cables for the physical computer security system.

The type of lock body can be varied and may be a quick-connect lock, a scissor-lock, or some other form of computer lock that can accept a cable collar to provide a physical computer security system with interchangeable cables. For simplicity, the lock bodies shown in the various figures are often represented as key-operated, scissor-lock computer locks, but other lock-types, such as combination-operated, are also known to those of skill in the art. It is appreciated that if the lock body is connected to a device, such as a computer, the cables are secure and cannot be removed. It is only when the lock body is disconnected from the computer that the interchange of cables is possible.

In FIG. 2, a side view of one embodiment of the physical computer security system for interchangeable cables is shown (the opposite end of the cable is not shown). More specifically, a representative lock body 20B is shown with a key 30 and a cable collar 40B attached to a cable 50. Referring to FIG. 2, the cable collar 40B is configured to click onto the lock body 20B using a compressible quick-connect mechanism 60 located on both or either side of the lock body 20B. By pressing the buttons 70A the hook or tooth-like mechanism can allow the collar to slip off the lock body to provide interchangeable cables for the physical computer security system.

In FIG. 3, a side view of one embodiment of the physical computer security system for interchangeable cables is shown (the opposite end of the cable is not shown). More specifically, a representative lock body 20C is shown with a key 30 and a cable collar 40C attached to cable 50. Referring to FIG. 3, the cable collar 40C slips onto the lock body 20C where a threaded end 23 of the lock body 20C remains visible when the cable collar 40C is installed on the lock body 20C. The cable collar 40C is secured onto the lock body 20C by using a threaded end piece 80. The threaded end piece 80 can be made of various durable materials including, but not limited to plastic, rubber, metal, foam rubber, silicone rubber, other polymers, or a combination of them. Additionally, the threaded end piece 80 can be made of a durable, yet flexible material allowing for a more secure fit against the computer when the lock body 20C is attached to the computer (not shown).

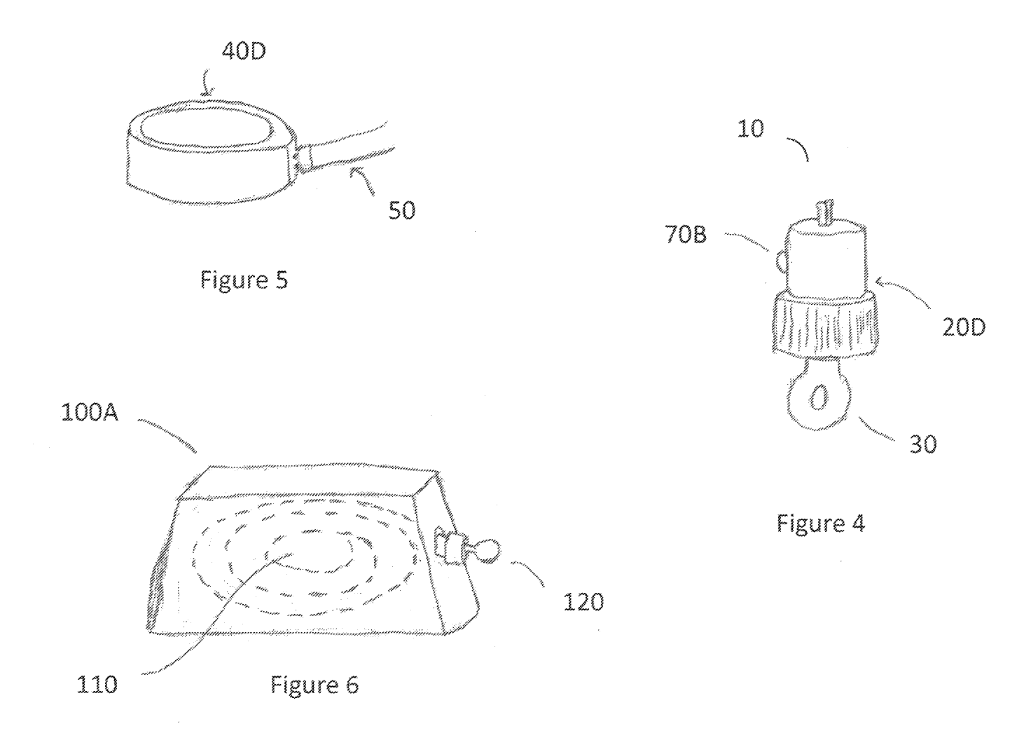

In FIG. 4, a side view of one embodiment of the physical computer security system for interchangeable cables is shown (the opposite end of the cable is not shown). More specifically, a representative lock body 20D is shown with a key. Referring to FIG. 4, the lock body 20D connects to a cable collar (not shown) via a compressible quick-connect mechanism 70B.

As noted previously, there are numerous mechanisms with which a cable collar can connect to a lock body in a quick-connect and/or quick-release fashion. Some mechanisms many include compressible buttons, or hook or tooth-like mechanisms as seen in FIGS. 4 and 2, respectively. Additionally, the quick-connect/quick-release mechanisms may include levers (not shown). It is also contemplated that the same quick-connect mechanism used to accept the cable collar may also be used to connect the lock body to the computer providing a one-step process of locking a computer to a system comprised of interchangeable cables.

In FIG. 5, one embodiment of an irreversibly connected cable collar of the physical computer security system is shown. More specifically, a representative cable collar 40D is shown attached to a cable 50. The cable is pivotally connected to the cable collar to provide range of motion. The cables will range in length and size and may contain a loop at the opposite end from the cable collar, or may be permanently attached to an anchor mount. It is also understood that for both the reversibly and irreversibly attached cables, the attachment of the cable to the cable collar may provide a wide range of motion (e.g. be pivotally attached), or be in a fixed orientation.

In FIG. 6, one embodiment of an anchor mount for interchangeable cables of the physical computer security system is shown. More specifically, an anchor mount 100A is shown containing a retraction mechanism 110 (coiled cable shown in phantom). Referring to FIG. 6, one end of the cable is attached irreversibly to the anchor mount (not shown). One of ordinary skill in the art would appreciate that the cable could be irreversibly attached to the anchor mount in a variety of ways depending on whether the preferred attachment was of a fixed orientation or with a wide range of motion (e.g. pivotally connected). The opposite end of the cable, the end to be connected to a cable collar, is shown in this embodiment as comprising a ball-type end 120 which can be used with a reversibly attached cable collar (as best seen in FIGS. 8A-8D). It is appreciated that the anchor mount 100A with a refraction mechanism 110 would also work well with cables with irreversibly attached cable collars (not shown), or other forms reversibly attached cable collars. In one embodiment, the reversibly attached cable collars contain various shapes which correspond to complimentary cable ends.

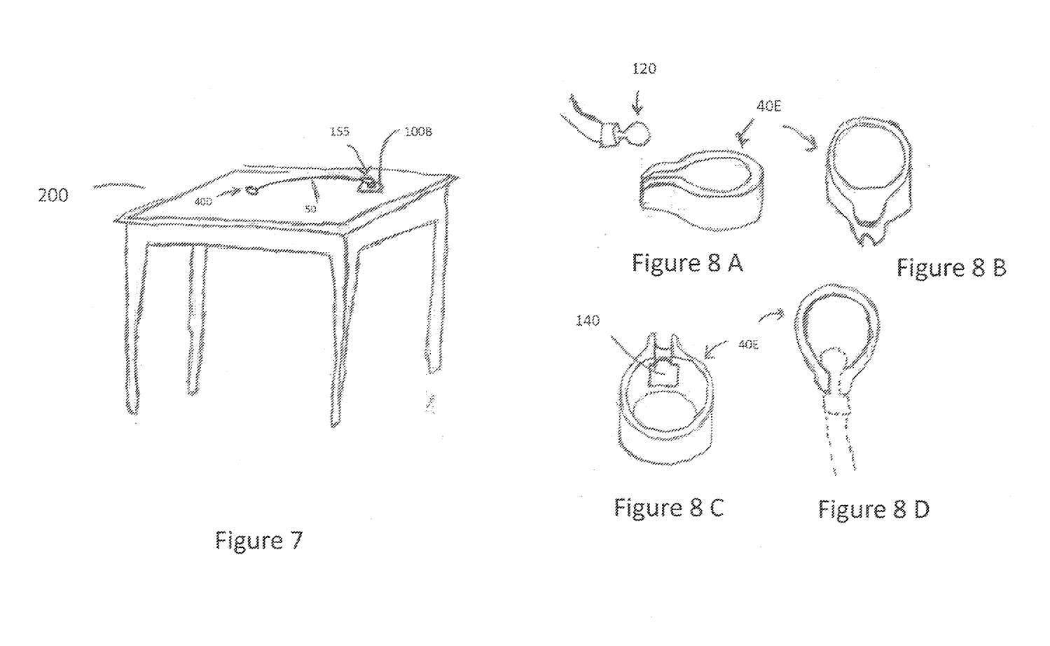

In FIG. 7, one embodiment of an anchor mount for interchangeable cables of the physical computer security system is shown. More specifically, a fixture 200 is shown with an anchor mount 100B attached. Here the fixture is a desk, but it is appreciated that any fixture could be used, such as benches, tables, chairs, desks, walls, and the like. In this embodiment, the anchor mount 100B does not contain a retraction mechanism. In this embodiment, the cable 50 is shown with a cable collar 40D and a loop 155 at the opposite end of the cable. The anchor mount could have the cable loop (and thus the cable) permanently attached, or the loop on the end of the cable could be slipped through the space provided by the anchor mount for temporary tethering. It is understood that the cable could also contain reversibly attached cable collars.

In FIG. 8A, FIG. 8B, FIG. 8C, and FIG. 8D several perspective views of one embodiment of a reversibly connected cable collar for interchangeable cables of the physical computer security system are shown. More specifically, the series of perspective views demonstrates one embodiment of a reversibly attached cable collar 40E. Here, a ball 120 and socket 140 mechanism is used to enable the quick interchange of the cable in to and out of the cable collar 40E to be used with the physical computer security system for interchangeable cables. It is understood that various complimentary shapes could be used, including spheres, cubes, pyramids, and the like.

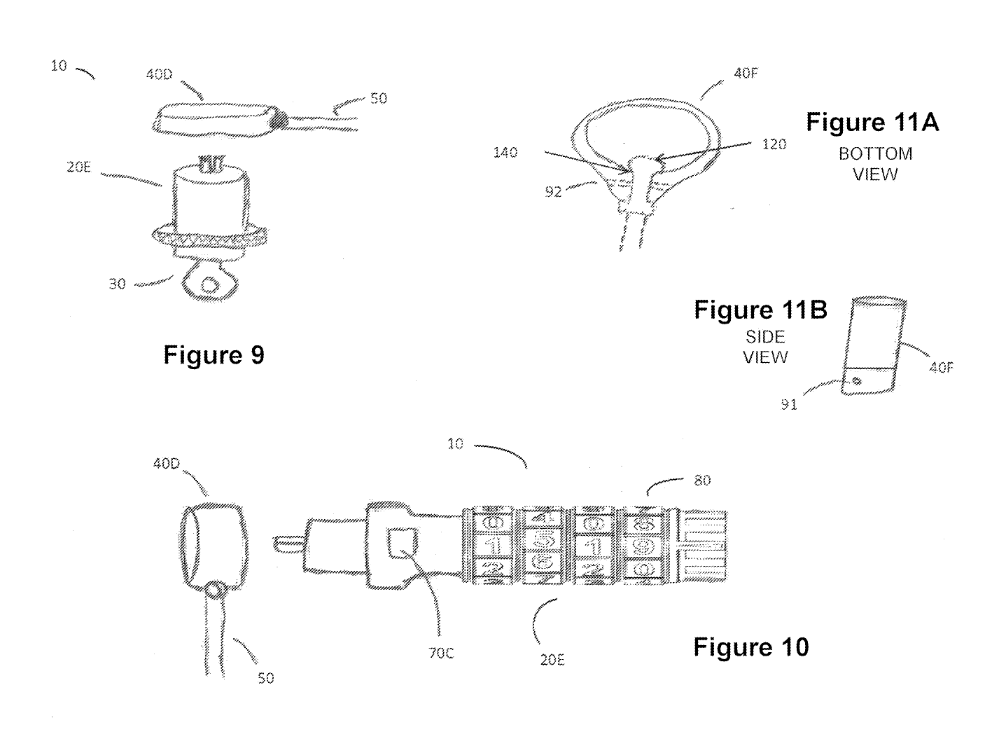

In FIG. 9, a side view of one embodiment of the physical computer security system for interchangeable cables 10 is shown (the opposite end of the cable is not shown). More specifically, a representative lock body 20E is shown with a key 30 and a cable collar 40D attached to a cable 50. Referring to FIG. 9, the cable collar 40D slips on the lock body 20E to provide interchangeable cables for the physical computer security system. The cable collar 40D is held in place when the lock is connected to a portable computer (not shown).

In FIG. 10, a side view of one embodiment of the physical computer security system for interchangeable cables 10 is shown (the opposite end of the cable is not shown). More specifically, a representative lock body 20E, here a combination lock, is shown with a cable collar 40D attached to a cable 50. Referring to FIG. 10, the cable collar 40D slips on to the lock body 20E to provide interchangeable cables for the physical computer security system. Also shown in FIG. 10 are rotatable mechanisms 80 for locking and unlocking the combination computer lock. A button 70C may also be present on the lock body 20E for use with a quick-connect/quick-release mechanism for the attachment or the release of the cable collar 40D to/from the lock body 20E.

In FIG. 11A and FIG. 11B, several perspective views of one embodiment of a reversibly connected cable collar for interchangeable cables of the physical computer security system are shown. More specifically, the series of perspective views demonstrates one embodiment of a reversibly attached cable collar 40F. Here, the cable is shown with a ball 120 and socket 140 mechanism (as best seen in FIGS. 8A-8D) is used to enable the quick interchange of the cable in to and out of the cable collar 40F to be used with the physical computer security system for interchangeable cables. It is understood that various complimentary shapes could be used, including spheres, cubes, pyramids, and the like.

Still referring to FIG. 11A and FIG. 11B, a roll or “spring pin” 91 could be installed behind the ball inside the collar to prevent its removal. The spring pin 91 could be inserted through two holes 92 so that it is visible on either side of collar or through one side (not shown) in a manner that would further frustrate removal because it would prevent someone from “punching it out” with an awl or similar device.

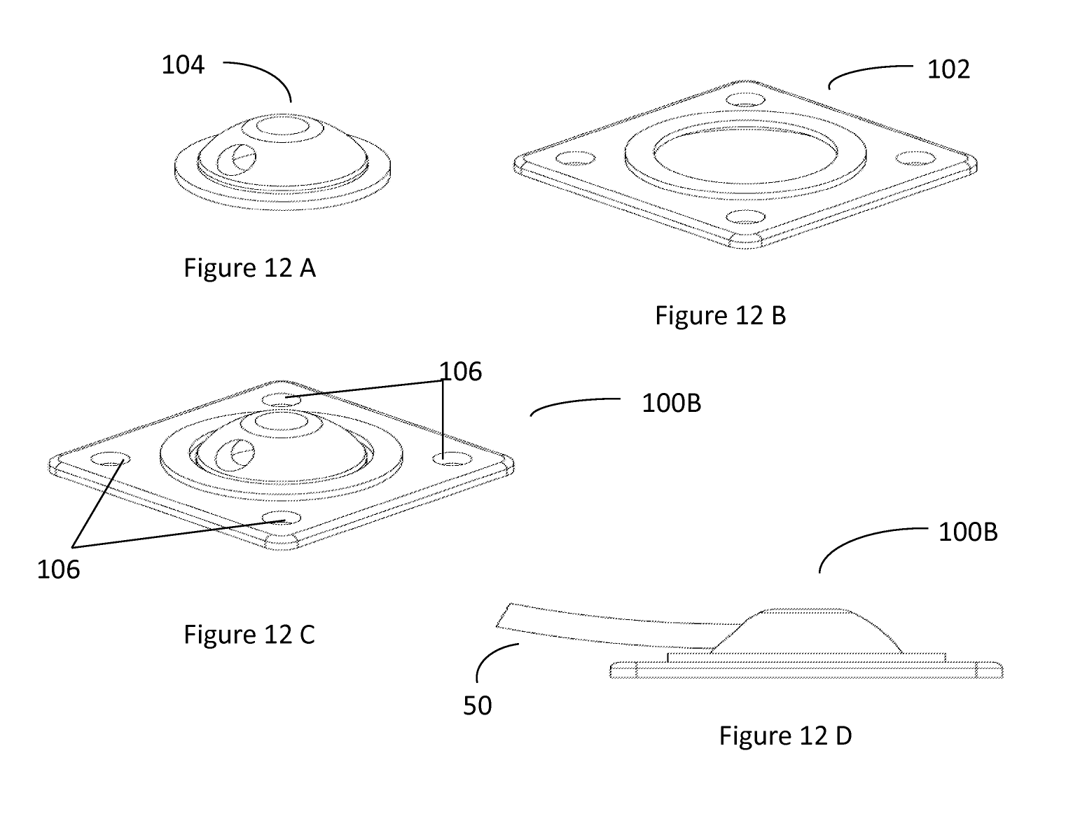

In FIG. 12 A, FIG. 12B, FIG. 12C, and FIG. 12D, several perspective views of one embodiment of a reversibly or irreversibly connected anchor mount for cables of the physical computer security system are shown. More specifically, the series of prospective views demonstrates one embodiment of a reversibly attached anchor mount 100B. Here, the anchor mount 100B is made up of a mounting portion 102 and a cable insert portion 104. The cable insert portion 104 is inserted through the bottom of the mounting portion 102 so that it is immovable when mounted. Also shown in FIG. 12 D is a cable 50 inserted into the anchor mount 100B. The anchor mount 100B can be attached to a surface (not shown) through mounting holes 106.

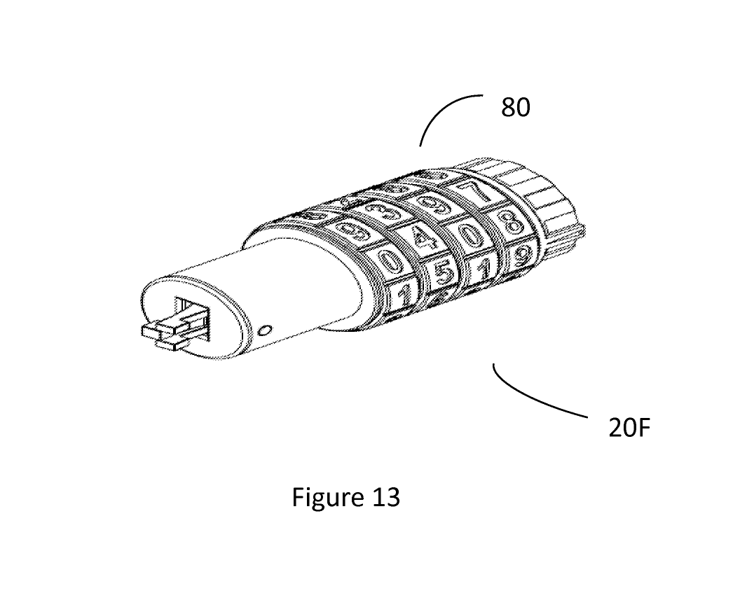

FIG. 13 shows a side view of one embodiment of a combination-lock physical computer security system. More specifically, FIG. 13 shows a series of combination dials 80, which can be used as a locking/unlocking mechanism on the lock body 20F.

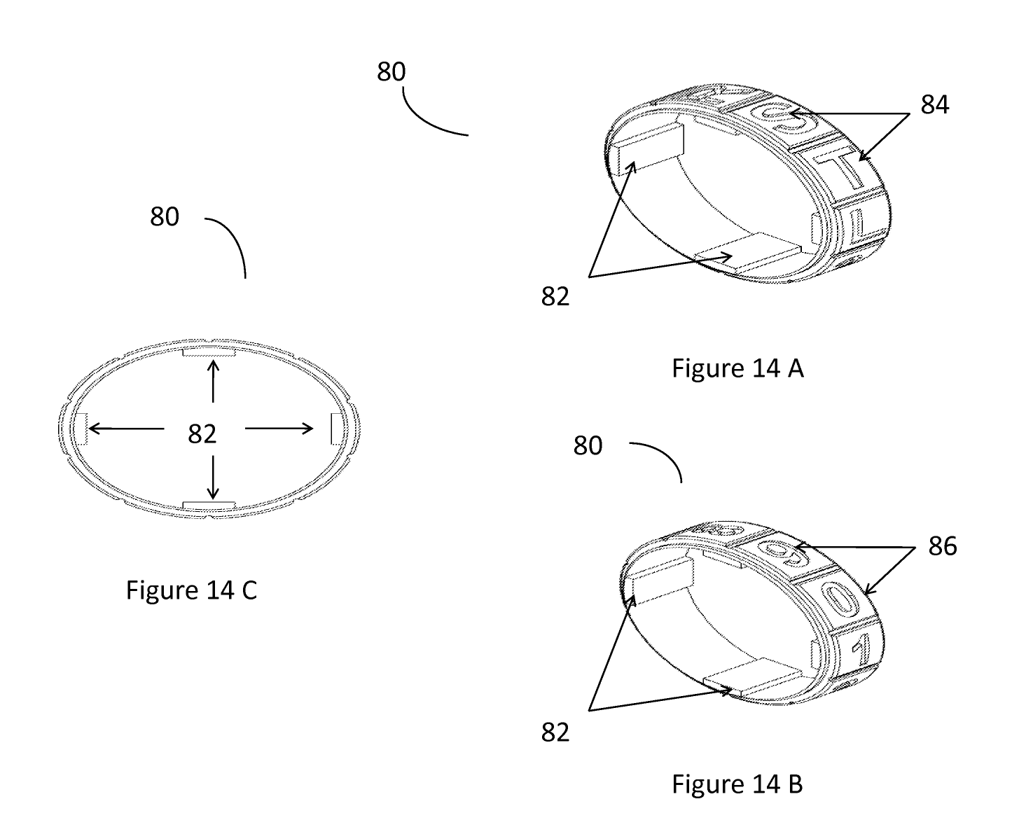

FIG. 14A, FIG. 14B and FIG. 14C show several perspective views of one embodiment of a combination dial used on a combination-lock. More specifically, FIG. 14A shows an embodiment of the invention of a combination dial 80 wherein the dial consists of a series of letters 84. FIG. 14B shows an embodiment of the invention of a combination dial 80 wherein the dial consists of a series of numbers 86. Also FIG. 14A, FIG. 14B and FIG. 14 C show a series of grooves 82 sized to communication with channels in an embodiment of a combination lock body (not shown). The grooves 82 may be sized differently to communicate with specific channels on the lock body to ensure proper alignment of the dials 80. The combination dials 80 are interchangeable on the lock body (not shown) and can have any number of dials 80 ranging from as few as three dials 80 to as many as ten dials 80.

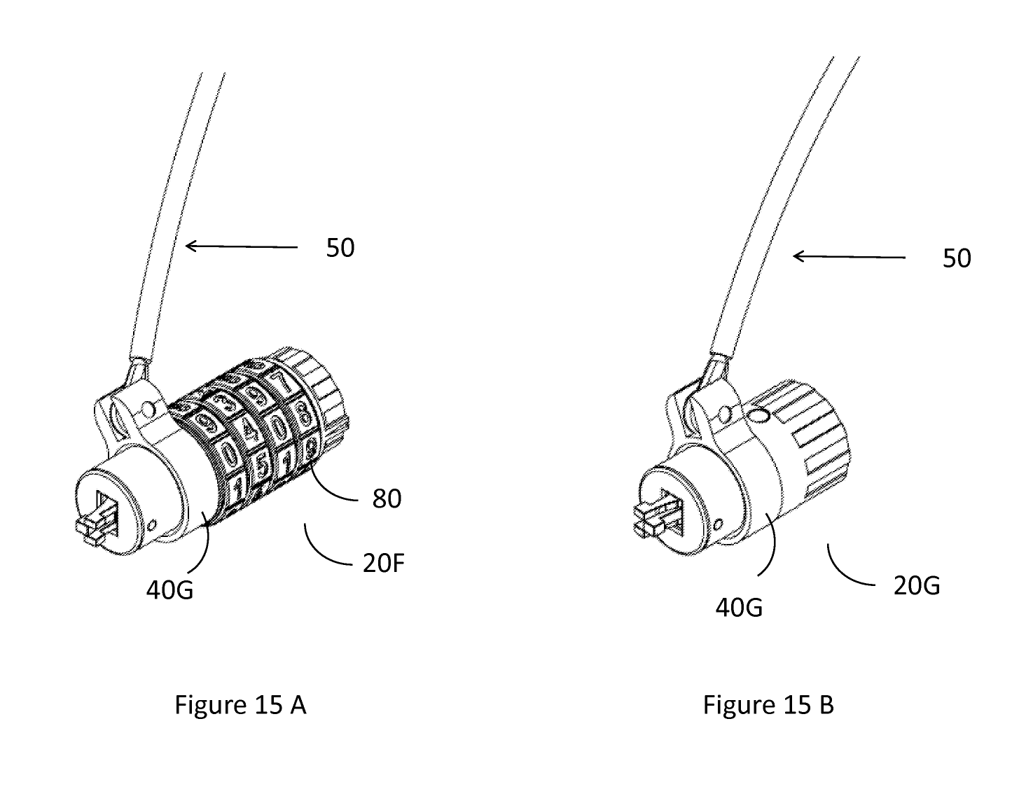

FIG. 15A and FIG. 15B are side-angled views of two embodiments of a physical computer security system for interchangeable cables. More specifically, FIG. 15A shows an embodiment of the invention where the lock body 20F is combination operated. The cable collar 40G, attached to cable 50, fits the lock body 20F to create the physical computer security system. FIG. 15B is a side-angled view of one embodiment of a physical computer security system for interchangeable cables. More specifically, the figure shows an embodiment of the invention where the lock body 20G is key operated. The cable collar 40G, attached to cable 50, fits the lock body 20G to create the physical computer security system.

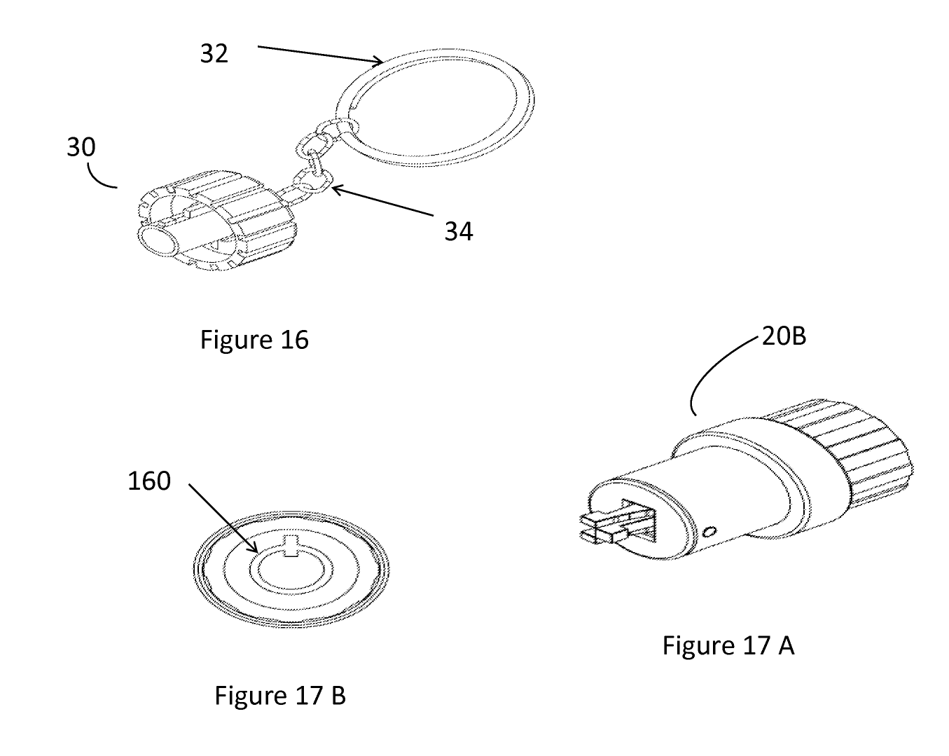

FIG. 16 is a side view of one embodiment of a key for a physical computer security system. More specifically, the figure shows the key 30 attached to a key chain 34 and key ring 32. When the key is inserted into the key-operated computer lock and turned into the unlock position, the key is locked into the lock body.

FIG. 17A and FIG. 17B show two perspective views of a key-operated physical computer security system. More specifically, FIG. 17B shows the back end of the key-operated lock body 20B and the keyhole 160. An embodiment of the key-operated lock body, when locked onto an embodiment of the key, shown in FIG. 16, allows the lock body to remain attached as a keychain.

The foregoing disclosures relate to preferred embodiments of the invention and modifications may be made without departing from the spirit and scope of the invention as set forth in, and limited only by, the claims herein.

In the claims herein—unless explicitly indicated otherwise—the use of the word “or” is to be construed as the inclusive “or” in accordance with common usage in the engineering and computer arts.

What is claimed is:

1. A security system for computers and computer peripherals comprising:
a plurality of cables, wherein each cable has a first end and a second end and is attached to a cable collar at the first end; and
a computer lock, wherein the computer lock comprises a lock body for receiving said cable collar, wherein said cable collar is securely retained on the lock body with an end piece removable only when the computer lock is not attached to a computer or a computer peripheral.

2. The security system for computers and computer peripherals of claim 1, wherein the cable is pivotally attached to the cable collar.

3. The security system for computers and computer peripherals of claim 1, wherein the computer lock is key-operated.

4. The security system for computers and computer peripherals of claim 1, wherein the computer lock is combination-operated.

5. The security system for computers and computer peripherals of claim 1, wherein the end piece comprises rubber.

6. The security system for computers and computer peripherals of claim 1, wherein the plurality of cables range in length to provide an assortment of cable lengths.

7. The security system for computers and computer peripherals of claim 1, wherein the cable is irreversibly attached to the cable collar.

8. The security system for computers and computer peripherals of claim 1, wherein the cable has a loop at the second end.

9. The security system for computers and computer peripherals of claim 1, wherein the second end of the cable is irreversibly attached to an anchor mount.

10. The security system for computers and computer peripherals of claim 9, wherein the anchor mount comprises a retraction mechanism for varying the effective length of the cable.

11. A security system for computers and computer peripherals comprising:
a plurality of cables, wherein each cable has a first end and a second end and the cable is attached to a cable collar at the first end; and
a computer lock, wherein the computer lock comprises a lock body for receiving said cable collar, wherein said cable collar is securely retained on the lock body with quick-release/quick-connect mechanism only when the computer lock is not attached to a computer or a computer peripheral.

12. The security system for computers and computer peripherals of claim 11, wherein the cable is pivotally attached to the cable collar.

13. The security system for computers and computer peripherals of claim 11, wherein the computer lock is key-operated.

14. The security system for computers and computer peripherals of claim 11, wherein the computer lock is combination-operated.

15. The security system for computers and computer peripherals of claim 11, wherein the end piece comprises rubber.

16. The security system for computers and computer peripherals of claim 11, wherein the plurality of cables range in length to provide an assortment of cable lengths.

17. The security system for computers and computer peripherals of claim 11, wherein the cable is irreversibly attached to the cable collar.

18. The security system for computers and computer peripherals of claim 11, wherein the cable has a loop at the second end.

19. The security system for computers and computer peripherals of claim 11, wherein the second end of the cable is irreversibly attached to an anchor mount.

20. The security system for computers and computer peripherals of claim 19, wherein the anchor mount comprises a retraction mechanism for varying the effective length of the cable.
